(19) United States
(12) Patent Application Publication
(10) Pub. No.: US 2007/0113964 A1
(43) Pub. Date: May 24, 2007

(54) Small water-repellant microphone having improved acoustic performance and method of constructing same

(76) Inventors: Scott A. Crawford, Castaic, CA (US); George Tziviskos, Encino, CA (US)

Correspondence Address: HENRICKS SLAVIN AND HOLMES, LLP;ADVANCED BIONICS CORPORATION, 840 APOLLO STREET, SUITE 200, EL SEGUNDO, CA, 90245, US

(21) Appl. No.: 10/295,733

(22) Filed: Nov. 15, 2002

Related U.S. Application Data
(60) Provisional application No. 60/338,990, filed on Dec. 10, 2001.

(51) Int. Cl. B32B 37/12; H04R 9/08

(52) U.S. Cl. 156/249; 156/289; 381/361

(57) ABSTRACT

A water-repellent microphone and an improved method for constructing such a water-repellent microphone provides easy assembly and good acoustic performance. In one embodiment, a water-repellent membrane and a washer are pre-assembled. The surface of the washer opposite the membrane is covered by an adhesive, and the adhesive is covered by a removable liner. The method of assembly comprises removing the liner, and pressing the membrane and washer over the sound port of the microphone. The washer provides spacing between the microphone and the membrane and increases the membrane area through which sound passes, thus providing good acoustic performance. In a second embodiment, the washer is provided as a separate element with adhesives and liners on both sides. A first liner is removed and the washer is attached to the membrane or the microphone, and then the second liner is removed and the assembly is completed.

The present application claims the benefit of U.S. Provisional Patent Application Ser. No. 60/338,990, filed Dic. 10, 2001, which application is incorporated herein by reference.

### BACKGROUND OF THE INVENTION

The present invention relates to the construction of small water-repellent microphones, and more particularly an improved method for the construction of a small water-resistant microphone, which method reduces the difficulty associated with handling small parts, and provides improved acoustic performance. Such small water-repellent microphone is well suited for use as the microphone of an Implantable Cochlear Stimulation (ICS) system, wherein the microphone is generally worn on the user's head, and is subject to moisture generally encountered in such use (e.g., perspiration, rain, fog, etc.)

Cochlear stimulation systems are known in the art. Such systems are used to help the profoundly deaf (those whose middle and/or outer ear is dysfunctional, but whose auditory nerve remains intact) to hear. The sensation of hearing is achieved by directly exciting the auditory nerve with controlled impulses of electrical current, which impulses are generated as a function of transduced acoustic energy. The acoustic energy is picked up by a microphone carried externally (not implanted) by the person using the device and converted to electrical signals. The electrical signals, in turn, are processed and conditioned by a signal receiver and processor, also referred to as a Wearable Processor (WP), in an appropriate manner, e.g., converted to a sequence of pulses of varying width and/or amplitude. The sequence of pulses, or command words that define such sequence of pulses, is carried by an external cable running from the WP to an external headpiece positioned on the side of the user's head. Generally, a magnet in the headpiece holds the headpiece in place. Such magnet also aligns the headpiece with a corresponding magnet in the implantable parts of the ICS system. Such implantable part receives the command words or pulse sequence, and converts them to appropriate stimulation current pulses that are applied to the auditory nerve through an electrode array implanted in the cochlea, as is known in the art.

While known ICS systems have succeeded in providing the sensation of hearing to the profoundly deaf, they unfortunately also have the disadvantage of appearing unsightly due to the external cable running from the WP to the headpiece positioned on the side of the user's head. The WP is typically worn or carried by the user on a belt or in a pocket. While the WP is not too large, it is likewise not extremely small, and hence also represents an inconvenience for the user. The cable which connects the WP with the headpiece is often a source of irritation and self-consciousness for the user.

The above-described aesthetic considerations, and inconvenience of an external wire, are addressed by U.S. Pat. No. 5,824,022, issued Oct. 20, 1998, for “Cochlear stimulation system employing Behind-The-Ear (BTE) Speech Processor With Remote Control.” The '022 patent teaches a small single external device that performs the functions of both the WP and the headpiece. The external device is positioned behind the ear to minimize its visibility, and requires no cabling to additional components. The '022 patent is incorporated herein by reference.

While the BTE device taught by the '022 patent resolves the issues of aesthetics and inconvenience, the resulting device, and known BTE hearing aids, disadvantageously include a microphone which is exposed to perspiration and rain, resulting in frequent failures. Therefore, there is a need for a microphone assembly that provides resistance to moisture, while maintaining a good frequency response. Further, due to the small size of known microphones used with BTE devices, the assembly of water-repellent microphone assemblies may be awkward and time consuming. Thus there is a further need for a construction method for small water-repellent microphones.

### SUMMARY OF THE INVENTION

The present invention addresses the above and other needs by an improved method for constructing a water-repellent microphone providing easy assembly and good acoustic performance. In one embodiment, a water-repellent membrane and a washer are pre-assembled. The surface of the washer opposite the membrane is covered by an adhesive, and the adhesive is covered by a removable liner. The method of assembly comprises removing the liner, and pressing the membrane and washer over the sound port of the microphone. The washer provides spacing between the microphone and the membrane and increases the membrane area through which sound passes. In a second embodiment, the washer is provided as a separate element with adhesives and liners on both sides. A first liner is removed and the washer is attached to the membrane or the microphone, and then the second liner is removed and the assembly is completed.

In accordance with one aspect of the invention, there is provided a water repellent membrane and washer assembly. The membrane and washer are provided attached to one another. An adhesive and liner reside on the side of the washer opposite the membrane. The water-repellent microphone may then be assembled by removing the liner, and pressing the membrane and washer against the surface of the microphone which includes the sound port. The requirement to apply an adhesive, or to assemble the water-repellent microphone in a fixture is thus eliminated. Further, the requirement to manually manipulate small parts is minimized.

It is an additional feature of the present invention to provide a separate membrane and washer. The washer includes adhesives and liners on both side. The washer may either be attached to the microphone first, or to the membrane first. As in the first embodiment, there is not need to handle a separate adhesive, or to assemble the water-repellent microphone in a fixture.

It is a further feature of the invention to provide a water repellent membrane and a washer, wherein the washer resides between the membrane and the soundport of the microphone. The acoustic performance of the water-repellent microphone is limited by the area of the membrane through which sound passes. If the membrane is attached directly to the microphone, the membrane area is limited by the size of the microphone sound port. The addition of a washer between the membrane and the microphone increases the area sound may pass through to the size of the passage through the washer, thus providing good acoustic performance,

It is an additional feature of the invention to provide a water-repellent seal between the membrane, washer, and microphone. The water-repellent microphone is assembled using an adhesive between the membrane and the washer, and between the washer and the microphone. Such adhesive provides a 360 degree seal to effectively repel the water from entering the microphone.

It is a another feature of the present invention to provide a method of pre-assembly of a membrane and microphone. In known applications, a microphone sub-assembly is constructed by inserting a membrane, washer, and microphone into a boot (or housing). Great care must be taken during assembly to properly position the members. By pre-assembling the membrane, washer, and microphone, a single member may be inserted into the boot, thus eliminating the need to position the individual members.

### BRIEF DESCRIPTION OF THE DRAWINGS

The above and other aspects, features and advantages of the present invention will be more apparent from the following more particular description thereof, presented in conjunction with the following drawings wherein:

FIG. 1 shows a Behind-The-Ear (BTE) device residing upon the ear of a user;

FIG. 2 shows a partial cross-section of the BTE device;

FIG. 3 depicts a cross-section of a microphone subassembly suitable for use with the BTE device;

FIG. 4 shows a water-repellent microphone suitable for use within the microphone subassembly;

FIG. 5 depicts a cross-sectional view of a second microphone subassembly suitable for use with the BTE device;

FIG. 6 shows a second water-repellent microphone suitable for use within the second microphone subassembly;

FIG. 7 depicts a BTE device including an In-The-Ear (ITE) microphone, residing upon the ear of a user;

FIG. 8 shows additional details of an earhook attachable ITE microphone;

FIG. 9 shows a plan view of a water-repellent membrane and washer;

FIG. 9A shows a cross-sectional view of a first membrane and washer assembly taken along line 9A-9A of FIG. 9, wherein a first adhesive resides upon a first side of the washer, and a second adhesive resides upon a second side of the washer, and wherein the washer is water-repellent attached to the membrane by the second adhesive;

FIG. 9B depicts the membrane and washer of FIG. 9A, wherein the membrane and washer are not attached;

FIG. 9C shows the membrane and washer assembly of FIG. 9A with a first release liner residing upon the first adhesive;

FIG. 9D shows the membrane and washer assembly of FIG. 9B with the first release liner residing upon the first adhesive and a second release liner resides upon the second adhesive;

FIG. 10A shows a cross-sectional view of a second membrane and washer assembly taken along line 9A-9A of FIG. 9, wherein the first adhesive resides upon the first side of the first washer, and the second adhesive resides upon the second side of the first washer, and wherein a third adhesive resides upon a third side of the second washer and a fourth adhesive resides upon a fourth side of the second washer, and wherein the first washer is water-repellent attached to the membrane by the second adhesive, and the second washer is water-repellent attached to the membrane by the third adhesive.

FIG. 10B depicts the membrane and washers of FIG. 10A, wherein the membrane and washers are not attached;

FIG. 10C shows the membrane and washer assembly of FIG. 10A, with the addition of the first release liner over the first adhesive, and a fourth release liner over the fourth adhesive; and

FIG. 10D shows the membrane and washer on FIG. 10B, with the first release liner residing upon the first adhesive, the second release liner resides upon the second adhesive, a third release liner resides upon the third adhesive, and the fourth release liner residing upon the fourth adhesive.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing the general principles of the invention. The scope of the invention should be determined with reference to the claims.

The water-repellent microphone of the present invention provides a simple and effective method for sealing the a sound port of a microphone against water, thus providing improved performance and reliability. It will be apparent to those skilled in the art that the present invention has application to microphones used for various purposes. While the exercise of the method to Implantable Cochlear Stimulation (ICS) systems will be described in detail in the following description, the exercise of the present invention to other applications is intended to come within the scope of the present invention.

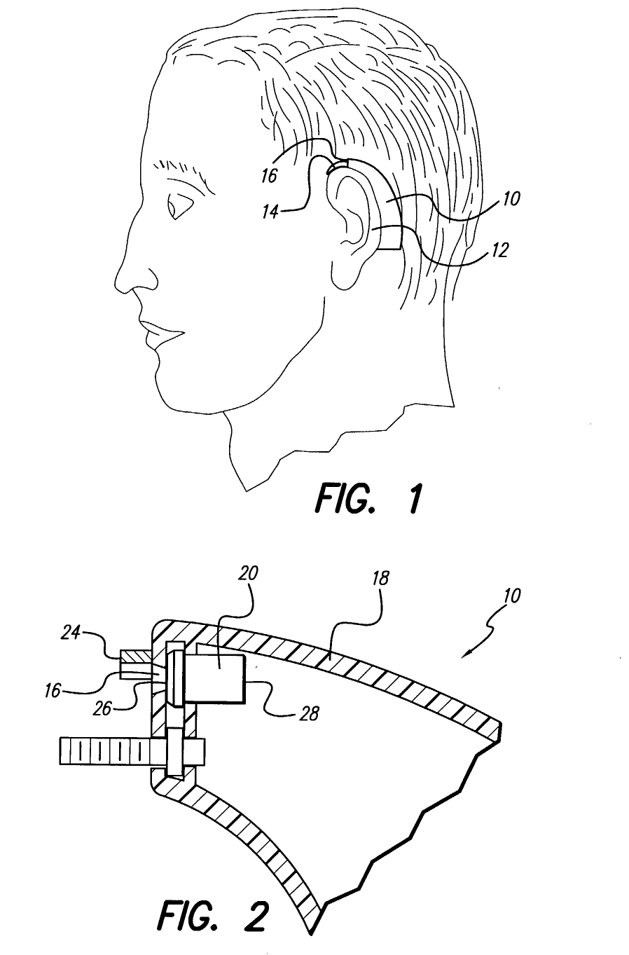

A Behind-The-Ear (BTE) hearing device 10 is shown carried and resting on an ear 12 of a user in FIG. 1. The BTE device 10 may either be a standard hearing aid, or the external electronics for an Implantable Cochlear Stimulation (ICS) system. In either case, a microphone is required to receive acoustic energy (i.e., sound waves) and convert the acoustic energy into an electrical signal for further processing. In order to receive the acoustic energy, the microphone must be open to at least some extent to the environment.

As can be seen in FIG. 1, the BTE device 10 forms an arch that starts behind the ear 12 and reaches over the ear 12. The BTE device 10 ends near the top of the arch, and an earhook 14 continues the arch a short distance. In typical BTE hearing devices, the microphone resides in the BTE device 10 near the highest point of the arch, behind a microphone port 16. While the microphone port 16 is advantageously positioned to receive sound in a natural manner (i.e., from the direction the patient is looking), the position also exposes the microphone to various moisture sources. Such moisture sources include rain, splashed water, perspiration, etc. Such moisture may not only degrade a microphone's performance, but in some instances it may render the hearing device inoperable.

A cross-section of a portion of a BTE device 10 is shown in FIG. 2. A microphone subassembly 20 is positioned directly behind the microphone port 16 (see FIG. 2). A BTE device case 18 includes a water deflector 24 residing above the microphone port 16. The water deflector 24 advantageously deflects large volumes of water attempting to enter the microphone port 16. The microphone subassembly has an assembly front 26 which resides against the microphone port 16, and an assembly rear 28 opposite the assembly front 26.

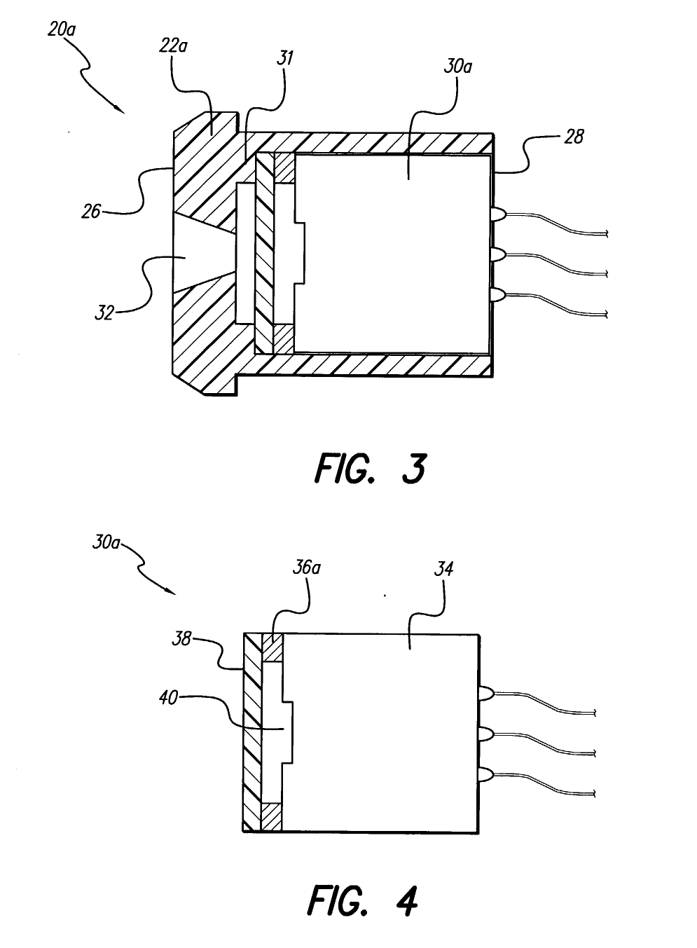

A cross-section of a first microphone subassembly 20a is shown in FIG. 3. The microphone subassembly 20a, is comprised of components assembled inside a first boot (or housing) 22a. The exterior of the boot 22a is shaped to cooperate with the BTE device case 18 to retain the microphone subassembly 20a in the BTE device case 18. The interior of the boot 22adefines a microphone cavity, wherein a water-repellent microphone 30a resides. A boot port 32 provides an opening to the water-repellent microphone 3a. The boot port 32 extends from the assembly front 26 (see FIG. 2) to the microphone cavity. The microphone cavity extends from the cavity front end abutting the boot port 32 to the cavity rear end coinciding with the assembly rear 28. When the microphone subassembly 20a is mounted in the BTE case 18, the boot port 32 is aligned with the microphone port 16 to provide an acoustic path for acoustic energy outside the BTE device 10 to enter the boot port 32. A step 31 is defined at a front end of the microphone cavity. The step 31 provides a surface for the water-repellent microphone 30a to seat against.

The water-repellent microphone 30a comprises a microphone 34, first washer 36a, and water-repellent membrane 38, as shown in FIG. 4. The membrane 38 is water-repellent attached to the washer 36a, and the washer 36a is water-repellent attached to the microphone 34, wherein the microphone port 40 is surrounded by the washer 36a. When inserted into the boot 22a (see FIG. 3), the membrane 38 resides against the step 31, thus providing a large membrane 38 surface for effective transmission of sound.

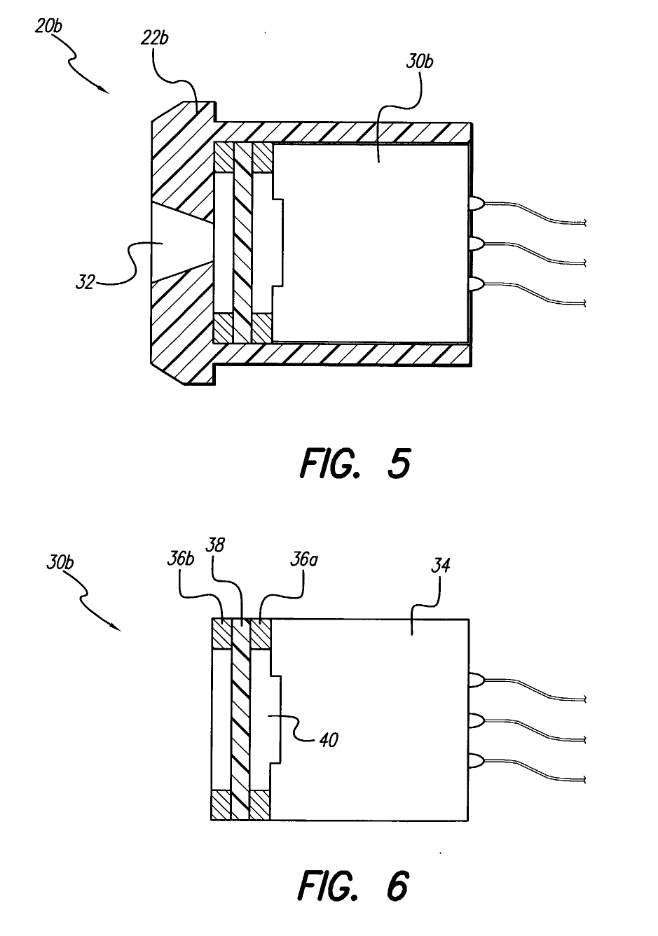

A cross-section of a second microphone subassembly 20b is shown in FIG. 5. The second microphone subassembly 20b is nearly identical to the first microphone subassembly 20a, except for the absence of a step, and an additional washer added to water-repellent microphone 30b. As shown in FIG. 6, the second water-repellent microphone 30b comprises the microphone 34, the first washer 36a, membrane 38, and additionally, a second washer 36b. The second washer 36b is water-repellent attached to the membrane 38, the membrane 38 is water-repellent attached to the washer 36a, and the washer 36a is water-repellent attached to the microphone 34, wherein the microphone port 40 is surrounded by the washer 36a. As is apparent by comparing FIGS. 4 and 6, the additional of the second washer 36b to the second water-repellent microphone 30b is the only difference between the first water-repellent microphone 30a, and the second water-repellent microphone 30b. When the second water-repellent microphone 30a is inserted in to the boot 22b, the second washer 36b resides against the front end of the microphone cavity, thus providing a large membrane 38 surface for effective transmission of sound.

Those skilled in the art will recognize that boots, microphone cavities, and sound ports may be made in a variety of shapes. Such other shapes, or combinations of shapes, are intended to come within the scope of the present invention.

An example of another type of microphone assembly that may be used with a BTE ICS system is disclosed in applicants' co-pending and co-owned U.S. patent application, Ser. No. 09/733,736, filed Dec. 8, 2000, entitled “Water-Resistant Microphone Subassembly”, which application is incorporated herein by reference.

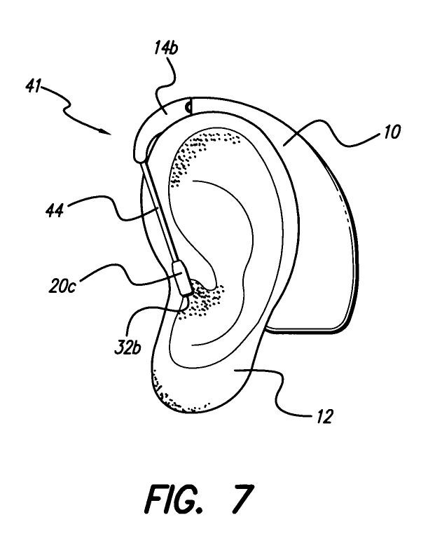

As an alternative to a BTE ICS system with a microphone residing in the BTE device, an In-The-Ear (ITE) microphone may be utilized with the BTE device. An ITE microphone earhook 40 and BTE device 10 are shown residing on the ear 12 of a user in FIG. 7. The ITE microphone earhook 40 comprises a second earhook 14b, a third microphone subassembly 20c, and a stalk 44. The microphone subassembly 20c is attached by the stalk 44 to the earhook 14b. The microphone subassembly 20c preferably resides behind the tragus and directed towards the concha of the ear, with a second boot port 32a facing downward and somewhat rearward. Some users may vary location of the microphone subassembly 20c, and these variations are intended to come within the scope of the present invention.

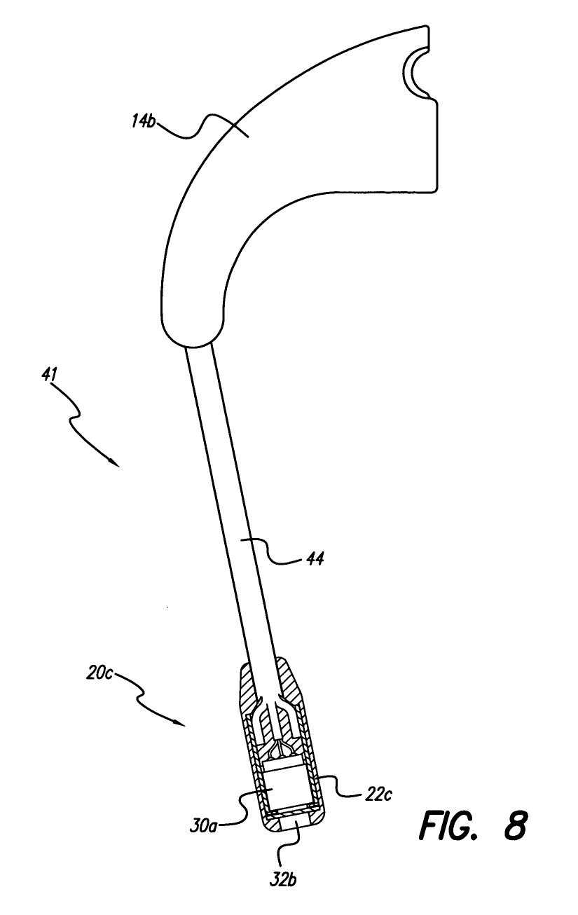

A more detailed view of the ITE microphone earhook 40 is shown in FIG. 8. The microphone subassembly 20c comprises the water-repellent microphone 30a, a third boot (or housing) 22c, and defines a sound boot port 32a. The microphone 30a (see FIG. 4) resides inside the boot 22c. Alternatively, the ITE microphone earhook 40 may also utilize a water-repellent microphone 30b as described in FIG. 6 above. Those skilled in the art will recognize that various other embodiments of an ITE microphone may be exercised. In each variation, similar environmental conditions motivate the use of a water-repellent microphone, and all of these variations utilizing a water-repellent microphone constructed as described herein are intended to come within the scope of the present invention.

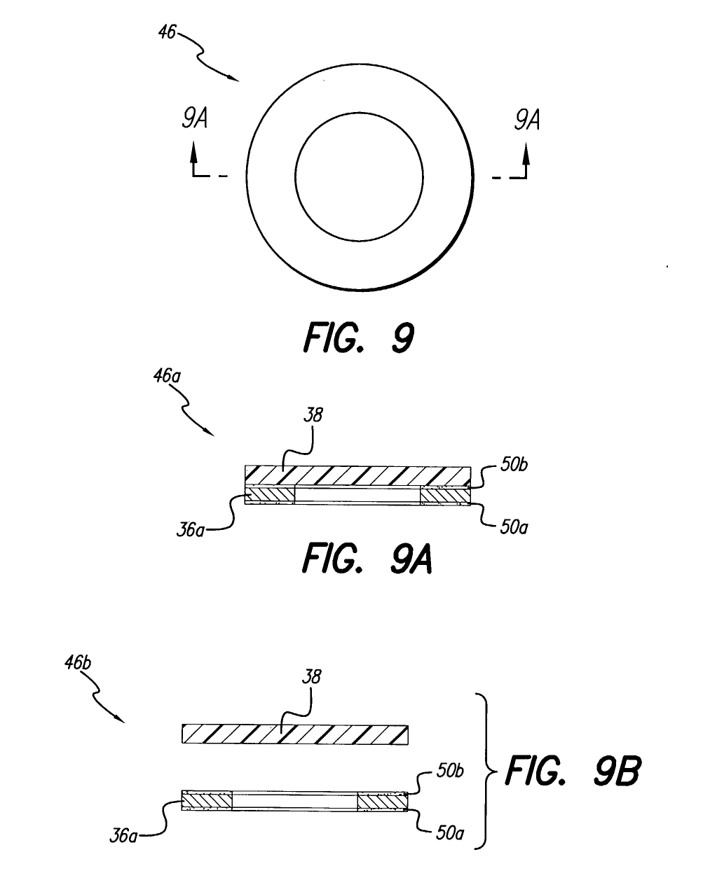

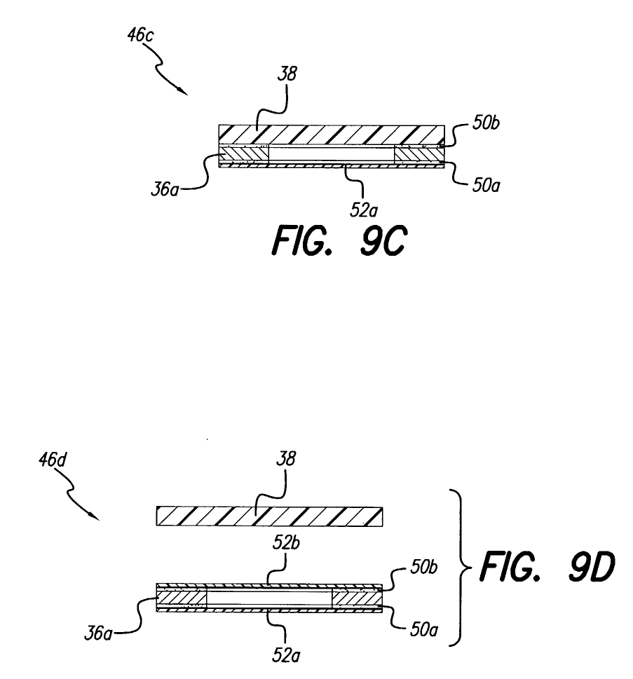

A plan view of a membrane and washer assembly 46 is shown in FIG. 9. A cross-sectional view of a first embodiment of the membrane and washer assembly 46 taken along line 9A-9A of FIG. 9 is shown in FIG. 9A. A first membrane and washer assembly 46a comprises the following elements: the membrane 38, the first washer 36a, a first adhesive 50a on a first side of the washer 36a opposite the membrane 38, and a second adhesive 50b on a second side of the washer 36a adjacent to the membrane 38. The membrane is preferably made from Versapor 10000R . The washer is preferably made from polyester. The adhesive 50a is preferably acrylic (3M VHB), whereas the adhesive 50b is preferably silicone-based or acrylic (3M VHB). The membrane and washer have about the same outside diameter, preferably between about 0.090 and 0.125 inches. The inside diameter of the washer is preferably between about 0.068 and 0.072 inches, wherein the washer defines a substantially cylindrical passage that passes through the center of the washer. The membrane 38 is preferably between about 0.005 and 0.010 inches thick, and the combined width of the combination of the washer 36a and the adhesives 50a, 50b is preferably between 0.008 and 0.010 inches thick. The water-repellent microphone 30a (see FIG. 4) in constructed by pressing the adhesive 50a against the end of the microphone 32 which includes the sound port 40 (see FIG. 6), wherein the washer 36a is substantially centered on the sound port 40 and encloses the soundport 40.

In another embodiment, the membrane and washer 46b as shown in FIG. 9B, are provided as a separate membrane 38 and washer 36a, wherein the adhesives 50a and 50b reside on the washer 36a. The construction of a water-repellent microphone using the membrane and washer 46b comprises pressing the adhesive 50a against the microphone, and pressing the adhesive 50b against the membrane, in any order, thereby constructing the water-repellent microphone 30a.

In yet another embodiment, a membrane and washer assembly 46c is provided with a release liner 52a residing over the adhesive 50a, as shown in FIG. 9C. In all aspects other than the addition of the release liner 52a, the membrane and washer assembly 46c is identical to the membrane and washer assembly 46a. The construction of the water-repellent microphone 30a using the membrane and washer assembly 46c includes a further step of removing the release liner before pressing the membrane and washer assembly 46c against the microphone 32.

In another embodiment of the present invention, a membrane and washer 46d includes release liner 52a over the adhesive 50a, and release liner 52b over adhesive 50b, as shown in FIG. 9D. In all aspects other than the addition of the release liners 52a and 52b, the membrane and washer assembly 46d is identical to the membrane and washer assembly 46b. The construction of the water-repellent microphone 30a using the membrane and washer assembly 46d includes a further step of removing the release liner 52a before pressing the membrane and washer assembly 46c against the microphone 32, and removing the release liner 52b before pressing the membrane 38 against the adhesive 50b.

A cross-sectional view of a membrane and washer assembly 46e is shown in FIG. 1A. The membrane and washer assembly 46e includes the first washer 36a, the membrane 38, and a second washer 36b. The washers 36a and 36b are water-repellent attached to the membrane 38 by the adhesive 50b and an adhesive 50c, respectively. The adhesive 50a resides on a first side of the washer 36a, which first side faces away from the membrane 38, and a fourth adhesive 50d resides on a fourth side of the second washer 36b, which fourth side faces away from the membrane 38. The membrane and washer assembly 46e may be attached to a microphone 32 by pressing the membrane and washer assembly 46e against the microphone 32., thus constructing the water-repellent microphone 30b (see FIG. 6).

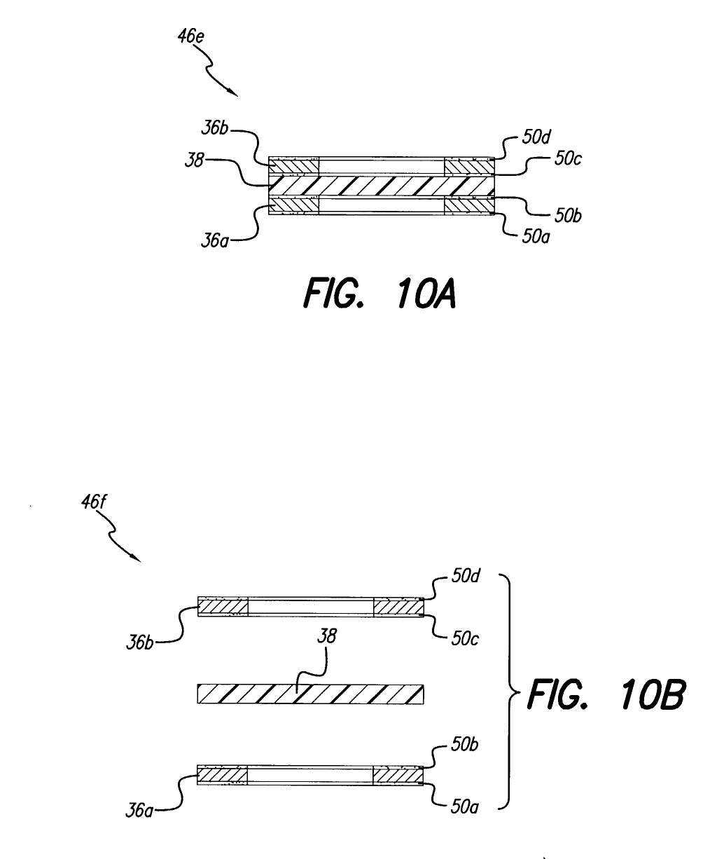

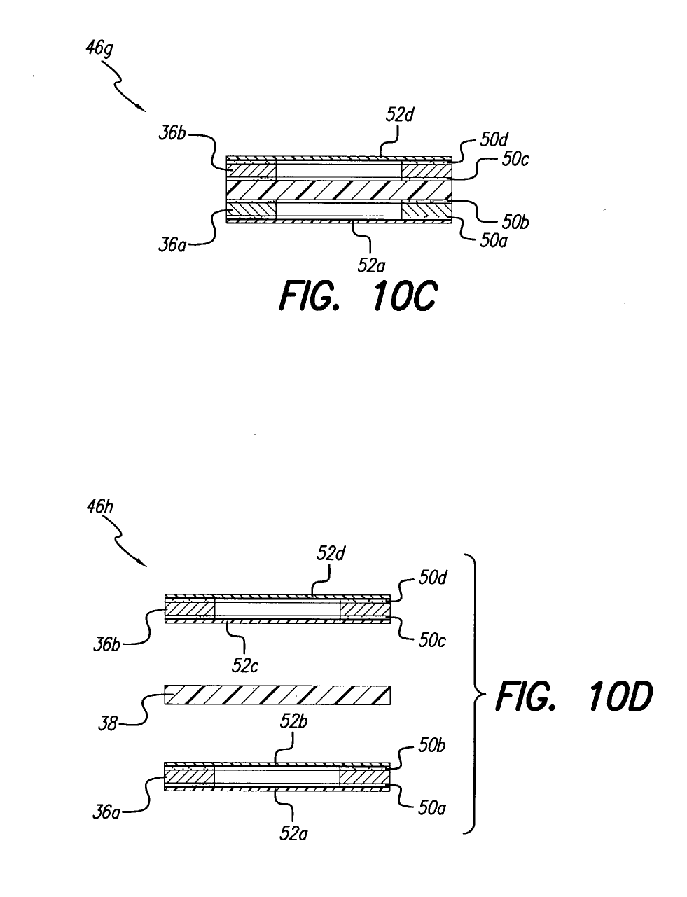

A membrane and washer 46f is shown in FIG. 10B comprising the first washer 36a, the membrane 38, and a second washer 36b, wherein the washer 36a includes the adhesive 50a on the first side, and the adhesive 50b on the second side, and the washer 36b includes a third adhesive 50c on a third side, and the fourth adhesive 50d on the fourth side. The water-repellent microphone 30b is constructed by pressing the first adhesive 50a against the microphone 32, pressing the membrane 38 against the second adhesive 50b, and pressing the third adhesive 50c against the membrane 38.

A membrane and washer assembly 46g shown in FIG. 10C comprises the membrane and washer assembly 46e with the further addition of the first release liner 52a over the adhesive 50a, and a fourth release liner 52d over the adhesive 50d. The water-repellent microphone 30b is constructed by removing the release liner 52a and pressing the adhesive 50a against the microphone 32.

An additional membrane and washer 46h is shown in FIG. 10D. The membrane and washer 46h comprises the membrane and washer assembly 46f with the further addition of the first release liner 52a over the adhesive 50a, the second release liner 52b over the adhesive 50b, a third release liner 52c over the adhesive 50c, and the fourth release liner 52d over the adhesive 50d. The water-repellent microphone 30b is constructed by removing the release liner 52a and pressing the adhesive 50a against the microphone 32, removing the second release liner 52b and pressing the membrane against the adhesive 50b, and removing the third release liner 52c and pressing adhesive 50c against the membrane.

In an alternative embodiment, the washer is attached to the membrane by methods other than adhesives. For example, the washer may be attached to the membrane by thermobonding or by ultrasonic bonding. Those skilled in the art will recognize these, and other boding techniques, which are intended to come within the scope of the present invention.

Those skilled in the art will recognize variations to the membrane and washers described above. In particular, the order of construction of the water-repellent microphones 30a and 30b may freely vary from the order the steps were recited in above. Further, the inclusion of a fourth release liner and a fourth adhesive are optional in the embodiments in which they are included.

While the invention herein disclosed has been described by means of specific embodiments and applications thereof, numerous modifications and variations could be made thereto by those skilled in the art without departing from the scope of the invention set forth in the claims.

1. A method for constructing a water-repellent microphone for use in a device, comprising:
providing a microphone including an exterior surface with a sound port;
providing a water-repellent membrane;
providing a washer including a first adhesive on a first side and a second adhesive on a second side; and
assembling the membrane, the washer, and the microphone to construct a water-repellent microphone prior to inserting the membrane, the washer and the microphone into the device, wherein the washer resides between the membrane and the microphone sound port and the first adhesive on the first side of the washer is in direct contact with the exterior surface of the microphone and surrounds the sound port.

2. The method of claim 1 wherein:
providing a washer including a first adhesive on a first side and a second adhesive on a second side comprises providing a washer including a first adhesive on a first side and a second adhesive on a second side, and further including a first release liner over the first adhesive and a second release liner over the second adhesive; and
assembling the membrane, the washer, and the microphone to construct a water-repellent microphone comprises:
removing the first release liner;
pressing the first side of the washer against the exterior surface of the microphone;
removing the second liner; and
pressing the membrane against the second side of the washer.

3. The method of claim 1 wherein the water-repellent membrane is constructed from an acrylic co-polymer on a non-woven nylon support.

4. The method of claim 1 wherein providing a washer including a first adhesive on a first side and a second adhesive on a second side comprises providing a washer including a first adhesive on a first side and a second adhesive on a second side, wherein the combination of the adhesives and the washer has a total thickness of between about 0.008 and 0.010 inches.

5. The method of claim 1 wherein providing a washer comprises providing a washer defining a substantially cylindrical passage through the washer, wherein the passage has a diameter of between about 0.068 and 0.072 inches in diameter.

6. The method of claim 1 wherein:
providing a washer comprises providing a washer having an outside diameter of between about 0.090 and 0.125 inches; and
providing a membrane comprises providing a membrane having an outside diameter of between about 0.090 and 0.125 inches.

7. The method of claim 1, wherein the device comprises a housing adapted to reside in a Behind-The-Ear (BTE) device, the method further comprising:
inserting the water-repellent microphone into the housing adapted to reside in a (BTE) device.

8. The method of claim 7 further comprising providing a second washer including a third adhesive on a third side and a fourth adhesive on a fourth side, and wherein:
assembling the membrane, the washer, and the microphone comprises assembling the second washer, the membrane, the washer, and the microphone, wherein the third side of the second washer is attached to the membrane on the side of the membrane opposite the washer; and
inserting the water-repellent microphone into the housing adapted to reside in a BTE device comprises inserting the water-repellent microphone into the housing adapted to reside in a BTE device wherein the fourth adhesive is adapted to retain the water-repellent microphone in the housing.

9. The method of claim 1, wherein the device comprises a housing adaptable for use as an element of an In-The-Ear (ITE) microphone assembly, the method further comprising:
inserting the water-repellent microphone into the housing adaptable for use as an element of an ITE microphone assembly.

10. The method of claim 9 further comprising providing a second washer including a third adhesive on a third side and a fourth adhesive on a fourth side, and wherein:
assembling the membrane, the washer, and the microphone comprises assembling the second washer, the membrane, the washer, and the microphone, wherein the third side of the second washer is attached to the membrane on the side of the membrane opposite the washer; and
inserting the water-repellent microphone into the housing adaptable for use as an element of an ITE microphone assembly comprises inserting the water-repellent microphone into the housing adaptable for use as an element of an ITE microphone assembly wherein the fourth adhesive is adapted to retain the water-repellent microphone in the housing.

11. A method for constructing a water-repellent microphone for use in a device, comprising:
providing a microphone including an exterior surface with a sound port;
providing a water-repellent membrane and washer assembly comprising a water-repellent membrane and a washer wherein the membrane and the washer are water-repellent attached, and wherein the washer includes a first adhesive on a first side of the washer opposite the membrane; and
assembling the membrane and washer assembly and the microphone to construct a water-repellent microphone prior to inserting the membrane and washer assembly and the microphone into the device, wherein the first side of the washer resides adjacent to the microphone sound port and wherein the first adhesive on the first side of the washer is in direct contact with the exterior surface of the microphone and attaches the washer to the microphone.

12. The method of claim 11 wherein:
providing a washer including a first adhesive on a first side comprises providing a washer including a first adhesive on a first side and further including a release liner over the first adhesive; and
assembling the membrane and washer assembly and the microphone to construct a water-repellent microphone comprises:
removing the first release liner;
pressing the first side of the washer against the exterior surface of the microphone whereby the soundport is covered.

13. The method of claim 11 wherein providing a membrane and washer assembly includes providing a membrane constructed from an acrylic co-polymer on a non-woven nylon support.

14. The method of claim 11 wherein providing a membrane and washer assembly comprises providing a membrane and washer assembly which has a total thickness of between about 0.016 and 0.020 inches.

15. The method of claim 11 wherein providing a membrane and washer assembly includes providing a washer defining a substantially cylindrical passage through the center of the washer, wherein the passage has a diameter of between about 0.068 and 0.072 inches.

16. The method of claim 11 wherein providing a membrane and washer assembly comprises providing a washer having an outside diameter of between about 0.090and 0.125 inches; and
providing a membrane having an outside diameter of between about 0.090and 0.125 inches.

17-21. (canceled)

22. A method of constructing a water-repellent hearing device, comprising:
providing a hearing device case including a microphone port;
providing a microphone including an exterior surface with a sound port;
providing a water-repellent membrane;
providing a washer including a first adhesive on a first side and a second adhesive on a second side;
assembling the water-repellent membrane, the washer, and the microphone into a water-repellent microphone wherein the washer resides between the membrane and the microphone sound port and the first adhesive on the first side of the washer is in direct contact with the exterior surface of the microphone and surrounds the sound port; and
inserting the assembled water-repellent microphone into the hearing device case such that the microphone sound port is substantially aligned with the hearing device case microphone port.

23. The method of claim 22, wherein:
providing a washer comprises providing a washer including a first adhesive on a first side, a second adhesive on a second side, a first release liner over the first adhesive and a second release liner over the second adhesive; and
assembling the water-repellent membrane, the washer, and the microphone comprises assembling the water-repellent membrane, the washer, and the microphone into a water-repellent microphone by removing the first release liner, pressing the first side of the washer against the exterior surface of the microphone such that the first adhesive surrounds the sound port, removing the second liner, and pressing the water-repellent membrane against the second side of the washer.

24. The method of claim 22, further comprising the step of:
inserting the assembled water-repellent microphone into a boot prior to inserting the assembled water-repellent microphone into the hearing device case.
